(19) United States
(12) Patent Application Publication
(10) Pub. No.: US 2014/0075708 A1
(43) Pub. Date: Mar. 20, 2014

(54) WIPER BLADE FOR CLEANING PANES, IN PARTICULAR OF MOTOR VEHICLES

(71) Applicant: Ruddy Crabbe, Linter (Neerhespen) (BE)

(72) Inventor: Ruddy Crabbe, Linter (Neerhespen) (BE)

(73) Assignee: ROBERT BOSCH GMBH, Stuttgart (DE)

(21) Appl. No.: 14/001,632

(22) PCT Filed: Feb. 16, 2012
(86) PCT No.: PCT/EP12/52717

§ 371 Date: Dec. 4, 2013

(30) Foreign Application Priority Data
Feb. 24, 2011 (DE) 102011004632.1

(51) Int. Cl. B60S 1/38

(52) U.S. Cl. CPC B60S 1/3874
USPC 15/250.48

(57) ABSTRACT

The invention relates to a method for production and to a wiper blade for wiping panes, in particular motor vehicle panes, comprising a support element (12) for receiving a wiper strip (14), to which support element a connecting device (20) is attached, which has a wiper blade-side part (15) having receptacles (34, 36) surrounding the support element (12) at least in some regions. According to the invention, the inner width (42) of the receptacles (34, 36) essentially corresponds to, or is slightly larger than, the thickness of the support element (12).

### BACKGROUND OF THE INVENTION

In the case of wiper blades for wiping panes, in particular motor vehicle panes, comprising a support element for receiving a wiper strip, to which support element a connecting device is attached, which has a wiper blade-side part having receptacles surrounding the support element at least in some regions, the support element is intended to ensure a distribution of the wiper blade contact pressure, which originates at the wiper arm and is as uniform as possible, over the entire wiping area wiped by the wiper blade. By means of a suitable curvature of the unloaded support element—that is when the wiper blade is not resting on the pane—the ends of the wiper strip, which strip rests fully on the pane when the wiper blade is in operation, are loaded towards the pane by the support element, which is then stressed, even if the radii of curvature of spherically curved motor vehicle panes vary at each position of the wiper blade. The curvature of the wiper blade has therefore to be somewhat greater than the greatest curvature measured in the wiping area on the pane to be wiped. A connecting device, via which the connection to the wiper arm is produced, is attached to the support element.

The European patent specification EP 0914269 B1 discloses a method for attaching the connecting device to the support element by means of a welded connection. To this end, the connecting element, which is located on the wiper blade side and consists of metal or a plastic material, is applied to or slid onto the support element and is connected to said support element in a materially boned manner by means of a resistance weld in the case of a metal connecting element or by means of an ultrasonic weld in the case of a plastic connecting element. This welded connection is daily subjected to extreme conditions and has to withstand high torques and vibrations at different weather conditions. In particular in the case of wiper blades that are manufactured in large numbers, a welded connection places high quality requirements on the process control and thereby makes the wiper blade more expensive, which is exactly what is to be avoided with mass-produced articles.

### SUMMARY OF THE INVENTION

The wiper blade according to the invention has the advantage that a welded connection can be avoided. A welded connection is replaced by a kind of clamping connection between the lugs of the wiper blade-side part of the connecting device and the support element. Since the inner width substantially corresponds to, or is only slightly larger than, the thickness of the support element, a positive- locking and force-fitting connection results.

In particular, the difference between the inner width and the thickness of the support element can lie in a tolerance band from 0 to 0.5 mm, preferably from 0 to 0.2 mm, at least however from 0 to 0.05 mm. The smaller the range of tolerance is selected, the better the connection will be between the wiper blade-side part and the support element even for a multiplicity of wiper blades in a mass production operation, wherein, however, the costs likewise rise.

Because the connecting device is slid over the support element during manufacture, it is an advantage for the inner width to be just large enough that the wiper blade-side part comprising the lugs thereof can be slid over the support element.

The connection between the wiper blade-side part and the support element is significantly improved by a heat treatment which at least affects the lugs. The heat treatment can have the effect that the distance between the lugs and the support element is reduced in the region of the inner width and that the adhesion increases. Heat staking is especially suitable in this case, wherein with negative pressure heat is directly introduced into certain regions of the lugs. The heat which was introduced and the applied pressure make a deformation of the lugs possible and close possible gaps between the support element and the lugs. The positive-locking and force-fitting connection is thereby considerably improved.

It is advantageous for the support element to comprise two spring rails which are spaced apart from one another and comprise one, preferably two, end cap(s) for covering the ends thereof. At least one of the end caps can have a spacer for the spring rails. The individual spring rails can be cost effectively manufactured and pre-bent to the required amount and then connected to the wiper blade-side part of the connecting device. By means of the one or the plurality of spacers, the resulting force on the connection between support element and connecting device is reduced.

The connecting devices can be provided with oblique contact surfaces in the region of the lugs in order to facilitate sliding the connecting device onto the support element.

The method according to the invention for producing wiper blades makes a cost effective production of mass produced wiper blades possible because the connecting device can be easily slid onto and positioned on the support element when force is applied. This results from the inner width of the wiper blade-side part being only slightly larger in relation to the thickness of the support element.

In order to reduce the amount of force applied when sliding the connecting device onto the support element, the two spring rails can be placed closely against one another prior to said connecting device being slid onto said support element and then be spaced apart from one another after said connecting device has been slid onto said support element.

The connection between the connecting part and the support element can be significantly improved if after positioning said connecting part on the support element, particularly the lugs are subjected to a heat treatment. This can preferably take place using heating jaws which join individual parts of the lugs to each other by means of heat staking.

The heating jaws are preferably pressed against each other in pairs such that top and bottom side of the lugs are pressed onto top and bottom side of the support element. It is also, however, conceivable to press heating jaws onto the outer longitudinal side of the lugs, wherein a spacer is inserted simultaneously between the spring rails so that the longitudinal sides of the spring rails are pressed into the lugs.

### BRIEF DESCRIPTION OF THE DRAWINGS

In the drawings:

FIG. 1 shows an inventive wiper blade in perspective depiction having a wiper arm indicated by a dot and dash line and the surface of a windshield indicated by a dot and dash line.

FIG. 2 shows a view along the line II-II in FIG. 1.

FIG. 3 shows a schematic depiction of the view according to FIG. 2 with only one spring rail.

FIG. 4 shows a schematic view in the viewing direction IV in FIG. 1 with only one end cap and

FIGS. 5 and 6 show exemplary embodiments having heat staking jaws in the vertical or, respectively, horizontal working direction.

### DETAILED DESCRIPTION

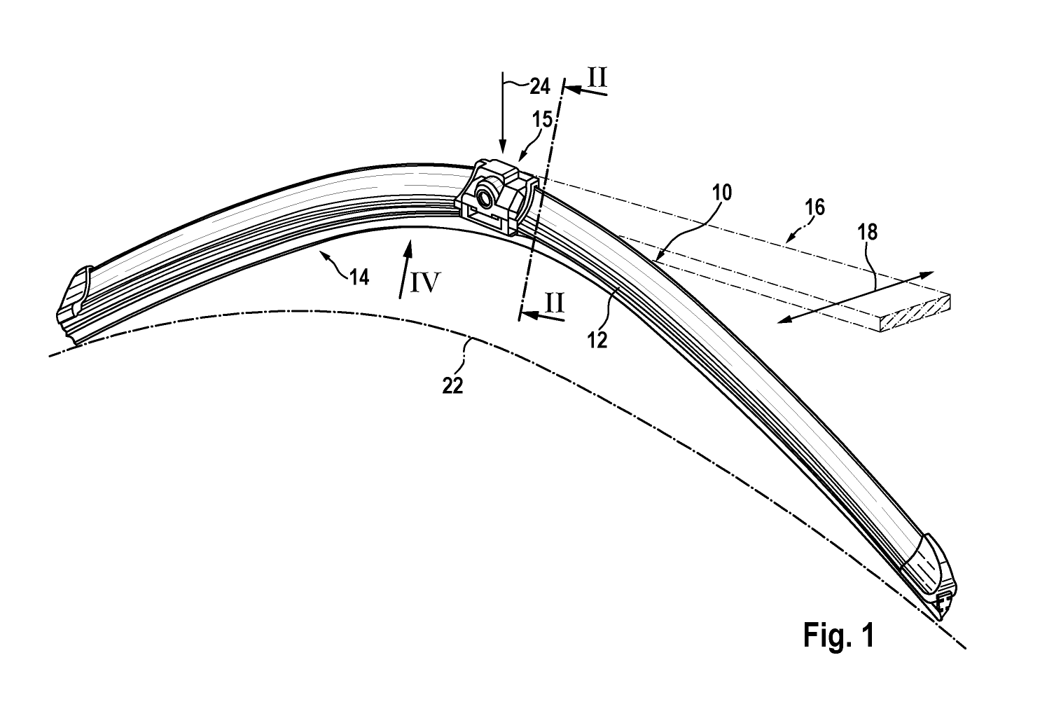

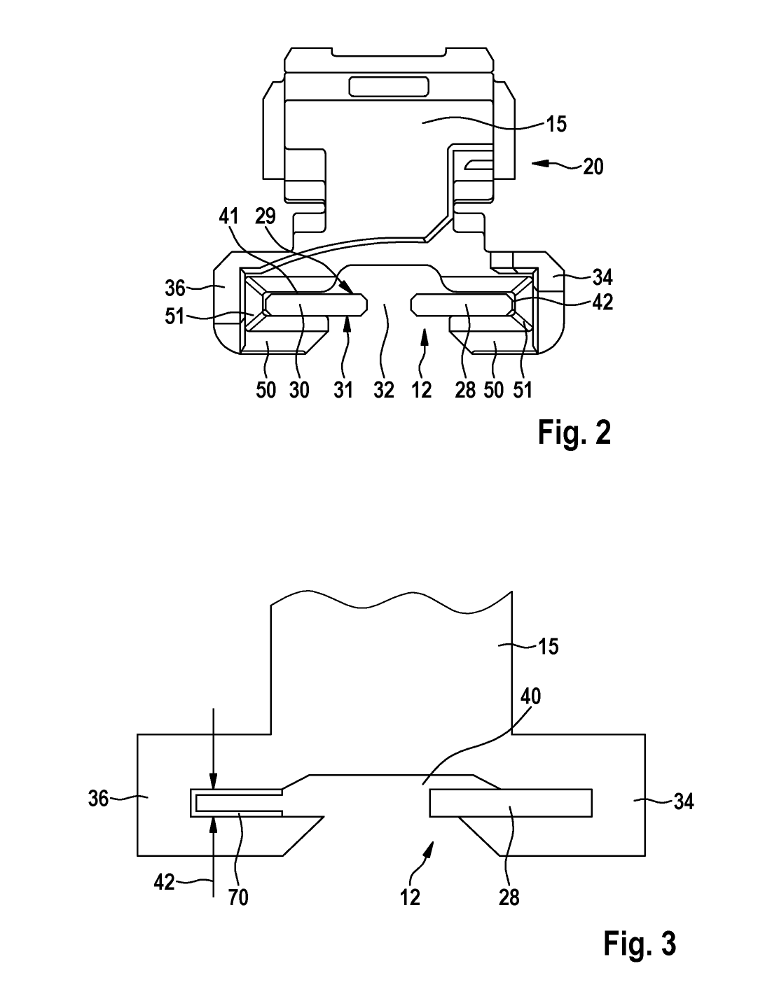

A wiper blade 10 shown in FIG. 1 comprises a spring-elastic support element 12 which is elongated in a band-like manner (FIGS. 1 and 2). An elongated, rubber-elastic wiper strip 14 is mounted on the lower band side 13 of said support element that faces the pane so as to be parallel to the longitudinal axis thereof. The wiper blade-side part 15 of a connecting device is disposed in a middle section on the upper band side 11 of the support element 12, which may also be referred to as a spring rail, said upper band side 11 facing away from the window pane. The wiper blade 10 can be connected releasably in an articulated manner to a wiper arm 16 indicated by a dot and dash line in FIG. 1 with the aid of the connecting device. The wiper arm 16, which is driven in an oscillating manner in the direction of a double arrow 18 in FIG. 1, is loaded in the direction of an arrow 24 towards the window pane to be wiped—for instance towards the windshield of a motor vehicle—the surface of which is indicated by a dot and dash line 22 in FIG. 1. Because the line 22 is intended to represent the greatest curvature of the window pane surface, it can clearly be seen that the curvature of the as yet unloaded wiper blade, which rests with both ends thereof on the window pane, is greater than the maximum curvature of the window pane (FIG. 1). Under the contact pressure (arrow 24), the wiper blade 10 comes to rest by means of the wiper lip 26 thereof over the entire extent thereof against the window pane surface 22. At the same time, a stress builds up in the spring-elastic support element 12, which is manufactured from metal, said stress ensuring proper contact of the wiper strip 14 or of the wiper lip 26 over the entire length thereof with the window pane surface 22 and uniform distribution of the contact pressure (arrow 24).

The special configuration of the wiper blade according to the invention will now be discussed in more detail below.

It can be seen in FIG. 2 that the support element 12 is constructed from two spring rails which are separated from one another, spaced apart from one another and define a gap 32. The connecting device 15 comprises two U-shaped receptacles 34 and 36 in a lower region, in which receptacles the spring rails 28 and 30 are accommodated. The receptacles 34 and 36 encompass the spring rails 28 and 30 in each case over a larger part of the cross section thereof, wherein the part of the connecting device 15 that corresponds to the wiper arm 16 is disposed on the convex side 29 of the support element 12, whereas the concave side 31 is opposite said convex side 29. A small gap 41 exists between the spring rails 28, 30 and the respective receptacle 34, 36.

The connecting device 15 is shown schematically in FIG. 3, wherein the corresponding spring rail 28 is depicted in the receptacle 34, whereas the spring rail 30 is not lying in the corresponding receptacle 36 so that the inner width 42 can be seen. The figure shows that the receptacles 34 and 36 suitably surround the spring rails 28, 30. The existing tolerances will be discussed later. In the region above the spring rails 28 and 30 and above the gap 32, the connecting device 15 comprises a recess 40 in which a head part of a wiper strip 14 comes to rest when the wiper blade is assembled.

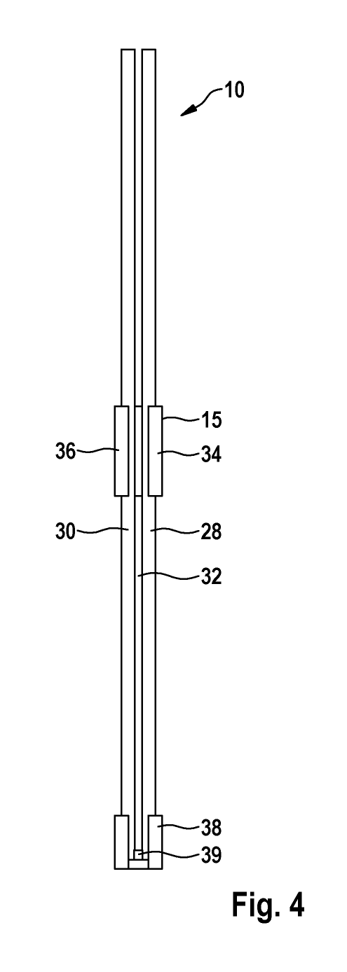

The wiper blade 10, which is depicted from below in FIG. 4 and is depicted without the wiper strip 14 or, respectively, the wiper lip 26, exhibits the spring rails 28 and 30, the gap 32 as well as the receptacles 34 and 36 of the connecting device 15. It can be seen that the spring rails 28 and 30 are completely separated from one another in this embodiment of the wiper blade 10 and are held together only by the connecting device 15 or via the end caps 38, of which only one at one end is depicted. At least one of the end caps 38 comprises a spacer 39 which in the assembled state keeps the spring rails 28, 30 at the distance of the gap 32.

In the method according to the invention, the wiper blade-side part 15 of the connecting device 20 is now slid onto the support element 12, for which purpose the wiper blade-side part 15 has an inner width 42 in the region of the receptacles 34, 36, said inner width 42 being equal to or slightly larger than the thickness of the spring rails 28, 30. To this end, the inner width is approximately 0 mm to at least 0.05 mm larger than the thickness of the spring rails 28, 30. The assembly is easier if the admissible tolerance band lies in the range from 0 mm to 0.2 mm. Increased demands are then, however, to be placed on the heat treatment. A very easy assembly can take place if said tolerance band lies between 0 mm to 0.5 mm, wherein it is then assumed that additional measures for reducing the gap 41 will be required after the heat treatment. In particular in the case of small gaps 41, the assembly of the wiper blade-side part 15 to the spring rails 28, 30 is to be carried out in such a fashion that the spring rails 28, 30 are held next to one another while reducing the gap 32, the wiper blade-side part 15 is slid onto the support element 12 and only then are the spring rails 28, 30 set to the distance of the gap 32 and thereby inserted into the receptacles. This method can, of course, also be advantageous for other tolerances.

In order to facilitate the insertion of wiper blade-side part and spring rails 28, 30 into one another, the receptacles 34, 36 have oblique contact surfaces 51 in the region of the claw-like lugs 50.

As soon as support element 12 and wiper blade-side part 15 have assumed the correct position with respect to one another, a heat treatment is begun which is either directed at the wiper blade-side part 15 or at the support element 12 or even at both elements. In so doing, the inner width 42 is changed in such a fashion that the gap 41 closes entirely or at least to a large extent.

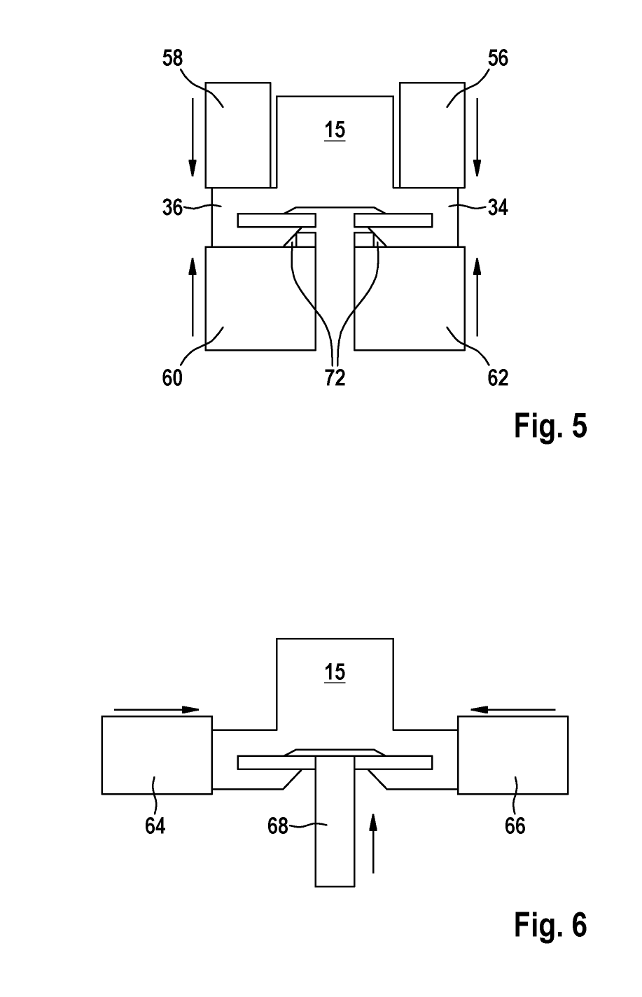

FIGS. 5 and 6 depict how heating jaws 56 to 68 act on the wiper blade-side part 15 or the spring rails 28, 30. In FIG. 5, the heating jaws 56. 58 are placed in each case on an upper side of the receptacles 34, 36, and simultaneously heating jaws 60, 62 from below are pressed against them. The now flowing heat provides the material of the receptacles the chance to plastically deform, in so doing to reduce the inner width 42 and to completely or partially close the gap 41. The temperature of the heating jaws 56 to 62, the effective force and the elapsed time ensue from empirical values dependent on material and size of the receptacles 34, 36 and are optimized by a small series of tests.

FIG. 5 shows schematically that the heating jaws can be contoured in order to be able to act on the receptacles 34, 36 in a locally intensified manner. To this end, the heating jaws 60, 62 comprise narrow protuberances 72 with which they act on the lower edge region of the receptacles 34, 36 and impress one or a plurality of notches. In so doing, the pressure increases in a highly localized manner and leads to a short-termed flow of the material. Depending on the surface composition of the spring rails 28, 30, the two parts to be joined can be interlocked or even bonded together.

As can be seen in FIG. 6, the heating jaws 64, 66 can also act on the outer longitudinal sides of the receptacles 34, 36 and in so doing, the narrow sides of the spring rails 28, 30 can dig themselves into the receptacles 34, 36. In order to absorb the pressure on the spring rails 28, 30, a further heating jaw 68 is inserted into the gap 32 prior to the heat staking operation. Said heating jaw 68 preferably has a temperature, which allows the spring rails 28, 30 to heat up in such a way that they transfer their heat to the receptacles 34, 36.

The two methods depicted in FIGS. 5 and 6 can, of course, be combined with each other, wherein the size of the heating jaws 56 to 58 is to be correspondingly adapted.

In order to improve the adhesion between the material of the receptacles 34, 36 and the spring rails 28, 30, a coating 70 can be applied to the spring rails 28, 30 in the region of the inner width 42. This can be a coating that improves the flow properties. It is, however, also conceivable to implement a coating 70 which improves the adhesion or allows for adhesive bonding.

1. A wiper blade for wiping panes, comprising a support element (12) for receiving a wiper strip (14), to which support element a connecting device (20) is attached, which has a wiper blade-side part (15) having receptacles (34, 36) surrounding the support element (12) at least in some regions, characterized in that the receptacles (34, 36) have an inner width (42) which essentially corresponds to, or is slightly larger than, the thickness of the support element (12).

2. The wiper blade according to claim 1, characterized in that the inner width (42) lies in a tolerance band from 0 mm to 0.5 mm greater than the thickness of the support element (12).

3. The wiper blade according to claim 1, characterized in that the inner width (42) is just large enough that the wiper blade-side part (15) comprising the receptacles (34, 36) thereof can be slid over the support element (12).

4. The wiper blade according to claim 1, characterized in that the attachment of the wiper blade-side part (15) to the support element (12) is improved by a heat treatment affecting at least the receptacles (34, 36).

5. The wiper blade according to claim 1, characterized in that the inner width (42) is reduced by heat staking.

6. The wiper blade according to claim 1, characterized in that the support element (12) comprises two spring rails (28, 30) which are spaced apart from one another and ends of which are each covered by an end cap (38), wherein at least one end cap has a spacer (39).

7. The wiper blade according to claim 1, characterized in that the connecting device (20) comprises oblique contact surfaces (51) in a region of the receptacles (34, 36).

8. A method for production of a wiper blade comprising a support element (12) and a connecting device (20), which is attached to the support element (12) by means of a wiper blade-side part (15) comprising lugs that have an inner width, according to claim 1, characterized in that the wiper blade-side part (15) having an inner width (42) which is only slightly larger than the thickness of the support element (12) is slid onto and positioned on said support element when force is applied.

9. The method according to claim 8, characterized in that the support element (12) comprises two spaced spring rails, which are placed against each other before sliding on the wiper blade-side part (15) and after positioning said wiper blade-side part (15) are spaced apart at a correct distance from one another.

10. The method according to claim 8, characterized in that the wiper blade-side part (15) is heat treated after being positioned on the support element.

11. The method according to claim 8, characterized in that the wiper blade-side part (15) is heat staked by means of heating jaws (56 to 68).

12. The method according to claim 11, characterized in that heating jaws (56 to 68) are in each case pressed against one another in pairs in order to introduce heat and pressure to at least one of the top and bottom side and the longitudinal sides of the receptacles (34, 36).

13. The wiper blade according to claim 1, characterized in that the inner width (42) lies in a tolerance band from 0 mm to 0.2 mm greater than the thickness of the support element (12).

14. The wiper blade according to claim 1, characterized in that the inner width (42) lies in a tolerance band from 0 mm to 0.05 mm greater than the thickness of the support element (12).
